(19) United States
(12) Patent Application Publication
(10) Pub. No.: US 2021/0157065 A1
(43) Pub. Date: May 27, 2021

(54) ASYMMETRIC HARDENED FIBER OPTIC CONNECTOR ASSEMBLIES AND METHODS FOR USING THE SAME

(71) Applicant: Corning Research & Development Corporation, Corning, NY (US)

(72) Inventors: Alexander Vladislavov Kulev, Berlin (DE); Michael Wimmer, Berlin (DE); Sadik Yasar, Corning, NY (US)

(21) Appl. No.: 16/690,425

(22) Filed: Nov. 21, 2019

(51) Int. Cl. G02B 6/38

(52) U.S. Cl. CPC G02B 6/3887; G02B 6/3898; G02B 6/387; G02B 6/3831

(57) ABSTRACT

A fiber optic connector assembly terminating an optical fiber includes a connector housing including a front portion positioned opposite a rear portion of the connector housing and a centrally-disposed longitudinal axis extending from the front portion of the connector housing to the rear portion of the connector housing. An optical fiber bore of the ferrule may be offset from the centrally-located longitudinal axis of the connector housing. The connector assembly also has a cable adapter engaged with the connector housing and including an optical cable passageway and an optical fiber passageway. The optical fiber passageway defines a fiber buckling passageway and an inducement feature extending at least partially into the fiber buckling passageway, where the inducement feature is structurally configured to preferentially buckle an optical fiber extending along the fiber buckling passageway.

### BACKGROUND

The present disclosure generally relates to high-bandwidth optical communication and, more particularly, to asymmetric, small form factor optical connectors and optical cable assemblies for use in optical networks.

Communication networks are used to transport a variety of signals such as voice, video, data transmission, and the like. Traditional communication networks use copper wires in cables for transporting information and data. However, copper cables have drawbacks because they are large, heavy, and can only transmit a relatively limited amount of data. On the other hand, an optical waveguide is capable of transmitting an extremely large amount of bandwidth compared with a copper conductor. Moreover, an optical waveguide cable is much lighter and smaller compared with a copper cable having the same bandwidth capacity. Consequently, optical waveguide cables replaced most of the copper cables in long-haul communication network links, thereby providing greater bandwidth capacity for long-haul links. However, many of these long-haul links have bandwidth capacity that is not being used. This is due in part to communication networks that use copper cables for distribution and/or drop links on the subscriber side of the central office. In other words, subscribers have a limited amount of available bandwidth due to the constraints of copper cables in the communication network. Stated another way, the copper cables are a bottleneck that inhibit the subscriber from utilizing the relatively high-bandwidth capacity of the long-hauls links.

Conventional fiber optic connectors used as a drop link to a subscriber have comparatively large form factors, which can restrict the use of the fiber optic connectors in areas with restricted space, such as ductwork and the like. Furthermore, the comparatively large size of conventional fiber optic connectors may reduce the number of fiber optic connectors that may be connected to a port. Accordingly, a need exists for alternative fiber optic connectors.

### SUMMARY

In one embodiment, a fiber optic connector assembly terminating an optical fiber includes a connector housing including a front portion positioned opposite a rear portion of the connector housing and a longitudinal axis extending from the front portion of the connector housing to the rear portion of the connector housing, and a cable adapter engaged with the connector housing and including an optical cable passageway and an optical fiber passageway, the optical fiber passageway defining a fiber buckling passageway and an inducement feature extending at least partially into the fiber buckling passageway, where the inducement feature is structurally configured to preferentially buckle an optical fiber extending along the fiber buckling passageway.

In another embodiment, a connectorized fiber optic cable assembly includes a connector housing including a front portion positioned opposite a rear portion of the connector housing and a centrally-located longitudinal axis extending from the front portion of the connector housing to the rear portion of the connector housing, a cable adapter engaged with the connector housing and including an optical cable passageway and an optical fiber passageway, the optical fiber passageway defining a fiber buckling passageway and an inducement feature extending at least partially into the fiber buckling passageway, a ferrule positioned at least partially within the connector housing, the ferrule including an optical fiber bore, and a fiber optic cable extending along the optical cable passageway of the cable adapter, the fiber optic cable including an optical fiber extending along the optical fiber passageway to the optical fiber bore of the ferrule, where the optical fiber bore is offset from the centrally-located longitudinal axis where the inducement feature of the cable adapter is structurally configured to preferentially buckle the optical fiber.

In yet another embodiment, a method for optically coupling a connectorized fiber optic cable assembly to a port includes optically coupling an optical fiber of a connectorized fiber optic cable assembly to an optical port, the connectorized fiber optic cable assembly including a connector housing having a centrally-located longitudinal axis, a cable adapter engaged with the connector housing and including an optical cable passageway and an optical fiber passageway, the optical fiber passageway defining a fiber buckling passageway and an inducement feature extending at least partially into the fiber buckling passageway, a ferrule positioned at least partially within the connector housing, the ferrule including an optical fiber bore, where the optical fiber bore is offset from the centrally-located longitudinal axis and a fiber optic cable extending along the optical cable passageway of the cable adapter, the fiber optic cable including the optical fiber extending along the optical fiber passageway to the optical fiber bore of the ferrule, and engaging the optical fiber of the connectorized fiber optic cable assembly with the inducement feature, thereby preferentially buckling the optical fiber of the connectorized fiber optic cable assembly in a buckling direction.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate embodiments, and together with the description serve to explain principles and operation of the various embodiments.

### BRIEF DESCRIPTION OF THE DRAWINGS

FIG. 1A schematically depicts a perspective view of an example connectorized fiber optic cable assembly, according to one or more embodiments described and depicted herein;

FIG. 1B schematically depicts a front view of the connectorized fiber optic cable assembly of FIG. 1A, according to one or more embodiments described and depicted herein;

FIG. 1C schematically depicts a top view of the connectorized fiber optic cable assembly of FIG. 1A, according to one or more embodiments described and depicted herein;

FIG. 1D schematically depicts a side view of the connectorized fiber optic cable assembly of FIG. 1A, according to one or more embodiments described and depicted herein;

FIG. 1E schematically depicts a side view of a connectorized fiber optic cable assembly including an asymmetric boot and a port assembly including a boot, according to one or more embodiments described and depicted herein;

FIG. 1F schematically depicts an exploded view of the connectorized fiber optic cable assembly of FIG. 1A, according to one or more embodiments described and depicted herein;

FIG. 2 schematically depicts a section view of the connectorized fiber optic cable assembly of FIG. 1D along section 2-2 of FIG. 1D, according to one or more embodiments described and depicted herein;

FIG. 3 schematically depicts an enlarged section view of the connectorized fiber optic cable assembly of FIG. 2, according to one or more embodiments described and depicted herein;

FIG. 4 schematically depicts a perspective view of a ferrule of the connectorized fiber optic cable assembly of FIG. 1A, according to one or more embodiments described and depicted herein;

FIG. 5A schematically depicts a rear perspective view of the ferrule of FIG. 4 positioned at least partially in the fiber optic cable assembly of FIG. 1A, according to one or more embodiments described and depicted herein; and

FIG. 5B schematically depicts another rear perspective view of the ferrule of FIG. 4 positioned at least partially in fiber optic cable assembly of FIG. 5A, according to one or more embodiments described and depicted herein.

### DETAILED DESCRIPTION

Embodiments are directed to optical cables and connectors in an optical waveguide network, and particularly in optical cables and connectors providing fiber-to-the-location-‘x’ (FTTx), where ‘x’ in the acronym represents the end location of the optical waveguide. For instance, FTTC represents a fiber to the curb application, and FTTP represents a fiber to the premises application. FTTP architectures advantageously route at least one optical waveguide to the premises, thereby providing a high bandwidth connection to the subscriber. Applications to locations other than to the curb or premises are also possible. In such networks, a drop link provides the optical fiber to the location. In the embodiments of the present disclosure, a drop link comprises a preconnectorized fiber optic drop cable (hereinafter an optical cable assembly) suitable for outdoor environments. Preconnectorized cable assemblies described herein effectively and economically streamline the deployment and installation of optical waveguides into the last mile of the fiber optic network such as to the premises. Although, the network described above is directed to one type of FTTx architecture, other networks can employ the embodiments of the present disclosure. Other networks may include other suitable components such as distribution closures, amplifiers, couplers, transducers, or the like. Likewise, other networks besides FTTx architectures can also benefit from the concepts of the present disclosure.

Preconnectorized optical cable assemblies may be routed to a premises using different exemplary techniques. Preconnectorized optical cable assemblies may be routed to premises in an aerial application. Alternatively, preconnectorized optical cable assemblies may be routed to a premises in a buried application. In the aerial application, a first end of the preconnectorized cable assembly is attached at a first interface device located on a pole, and a second end is attached at an interface device located at the subscriber premises. In buried applications, the first and second ends of a preconnectorized optical cable assembly are respectively connected to an interface device located inside an enclosure at ground-level and at an interface device at the premises (e.g., an exterior wall of the premises). The interface devices include at least one optical receptacle for making the optical connection with an end of preconnectorized optical cable assembly.

In embodiments of the present disclosure, connectorized fiber optic cable assemblies include one or more asymmetric features that assist in reducing an outer perimeter of the connectorized fiber optic cable assembly (i.e., reducing the form factor of the connectorized fiber optic cable assembly). By reducing the form factor of connectorized fiber optic cable assembly, optical cable assemblies described herein may be suitable for use in environments having limited space, such as ducts and the like. Moreover, by reducing the form factor of the connectorized fiber optic cable assembly, the density of adjacent optical cable assemblies connected to a port connection assembly, such as a multiport, can be increased. Various embodiments of connectorized fiber optic cable assemblies including asymmetric features and reduced form factors will be described herein with specific reference to the appended drawings.

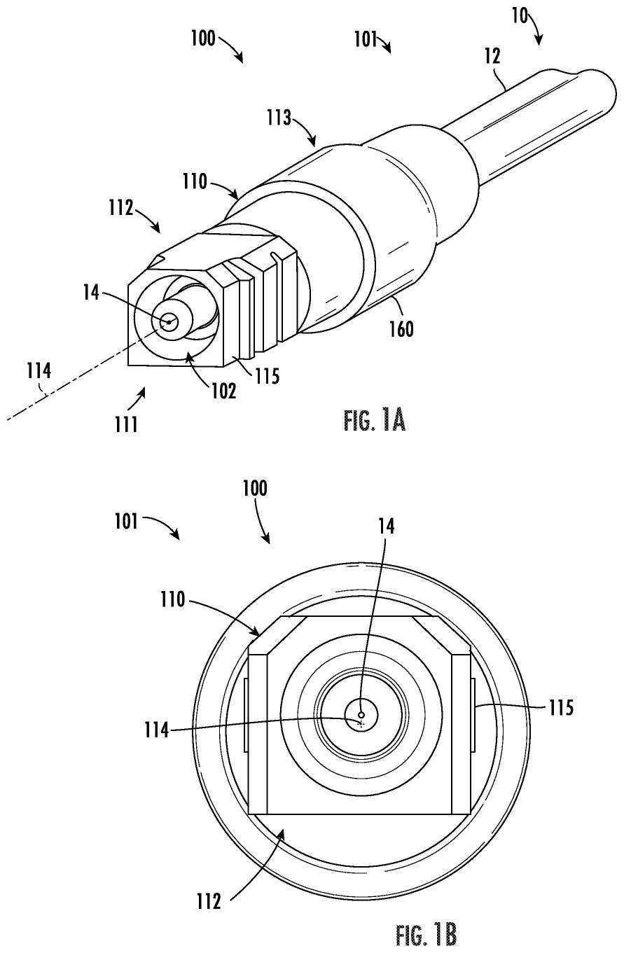

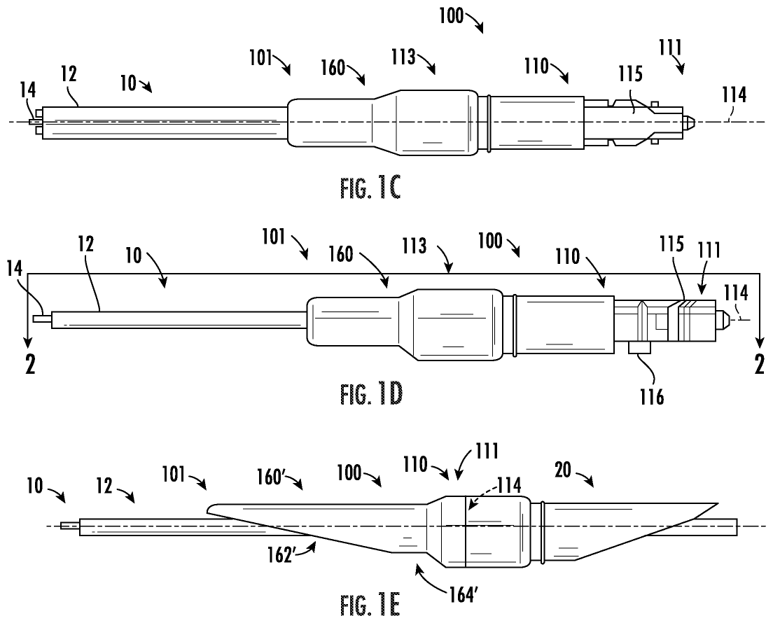

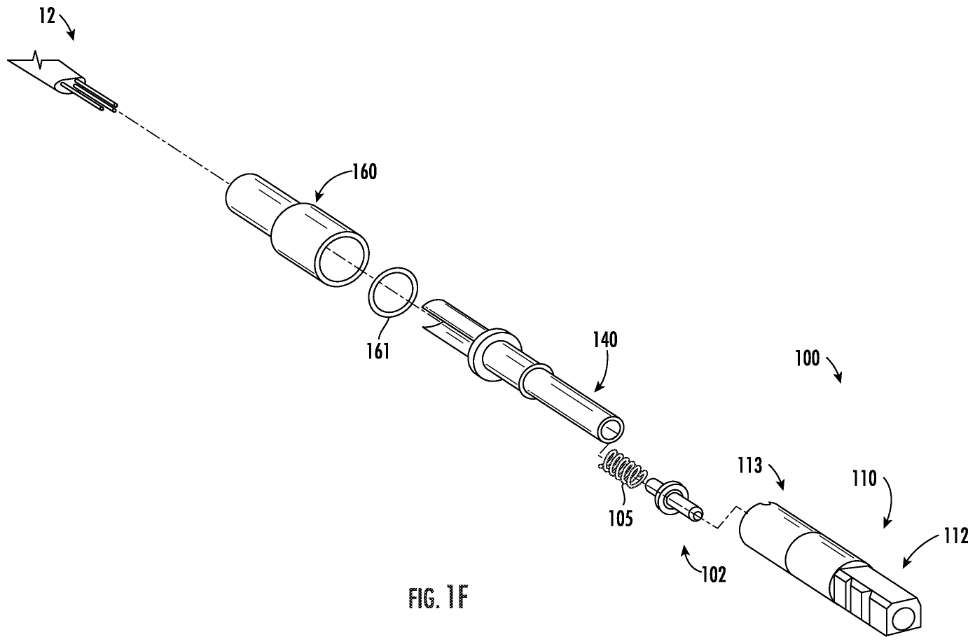

Referring to FIGS. 1A-1F, an example connectorized fiber optic cable assembly 101 including a fiber optic connector assembly 100 and a fiber optic cable 10 is schematically depicted. The fiber optic cable 10 generally includes a cable jacket 12 and one or more optical fibers 14 positioned within the cable jacket 12. The cable jacket 12 generally protects the optical fiber 14 from environmental elements, and may be formed of a polymer or the like. In the embodiment depicted in FIGS. 1A-1F, a single optical fiber 14 is schematically depicted, however, it should be understood that in embodiments, the fiber optic cable 10 may include any suitable number of optical fibers. Furthermore, it should be understood that in some embodiments, the fiber optic cable 10 may include components and features in addition to the optical fiber 14. For example, in some embodiments, the fiber optic cable 10 includes one or more strength elements that may reduce strain on the optical fiber 14. In some embodiments, the fiber optic cable 10 includes one or more wires, such as copper wires or the like, for the transmission of power and/or electrical signals.

The fiber optic connector assembly 100 generally includes a connector housing 110 extending between a front portion 111 and a rear portion 113 positioned opposite the front portion 111 in an axial direction. The connector housing 110 generally defines a longitudinal axis 114 that extends from the front portion 111 of the connector housing 110 to the rear portion 113 of the connector housing 110. In embodiments, the longitudinal axis 114 generally represents a centrally-disposed longitudinal axis of the rear portion 113 of the connector housing 110 (e.g., centrally-disposed means that the longitudinal axis is an axial center of the rear portion 113 of the connector housing 110).

In embodiments, the connector housing 110 includes a ferrule portion 112 positioned at the front portion 111 of the connector housing 110. In embodiments, a ferrule 102 is positioned at least partially within the ferrule portion 112, as described in greater detail herein. In embodiments, the fiber optic connector assembly 100 may include a biasing member 105 engaged with the ferrule 102.

In embodiments, the ferrule 102 defines an optical fiber bore 104 extending through the ferrule 102 in the axial direction, and when assembled, the optical fiber 14 extends through the optical fiber bore 104 of the ferrule 102. In some embodiments, the optical fiber 14 is coupled to the optical fiber bore 104. As shown in FIG. 1B, in some embodiments, the optical fiber bore 104 of the ferrule 102 is offset from the centrally-disposed longitudinal axis 114 of the connector housing 110, and accordingly, when the optical fiber 14 is inserted within the optical fiber bore 104, the optical fiber 14 is likewise offset from the centrally-disposed longitudinal axis 114 of the connector housing 110.

The front portion 111 of the connector housing 110 defines a perimeter 115. In some embodiments and as best shown in FIGS. 1B and 1D, the perimeter 115 of the front portion 111 of the connector housing 110 is offset from the centrally-disposed longitudinal axis 114. For example, in the embodiment depicted in FIGS. 1B and 1D, the front portion 111 defines a rectangular prism shape having a center that is offset from the centrally-disposed longitudinal axis 114.

Referring to FIG. 1D, in some embodiments, the connector housing 110 includes a connector locking feature 116. In embodiments, the connector locking feature 116 includes a locking tab or the like that is structurally configured to cooperate with a corresponding feature of a receiving port. For example and referring to FIGS. 1D and 1F, in embodiments, the connector housing 110 may be engaged with an optical port 20, such that the optical fiber 14 is optically coupled to a port optical fiber of the optical port 20. In embodiments, the connector locking feature 116 may engage with a corresponding locking feature of the optical port 20, restricting axial movement of the connector housing 110 with respect to the optical port 20. By restricting axial movement of the connector housing 110 with respect to the optical port 20, the connector locking feature 116 may assist in maintaining an optical connection between the optical fiber 14 and the port optical fiber of the optical port 20. While in the embodiment depicted in FIG. 1F the optical port 20 is depicted as being structurally configured to receive a single fiber optic connector assembly 100, it should be understood that fiber optic connector assemblies 100 described herein may be configured to mate with optical ports that receive multiple fiber optic connector assemblies, such as multiports or the like.

In embodiments, a boot 160 is positioned at least partially over the connector housing 110 (and heat shrink tubing, if utilized) and/or the fiber optic cable 10. The boot 160 may be formed from a flexible material such as KRAYTON, and may assist in sealing internal components of the fiber optic connector assembly 100 and the fiber optic cable 10 from environmental elements, such as moisture. For example, in some embodiments, the fiber optic connector assembly 100 may be utilized in an outdoor environment. In embodiments, the boot 160 may also provide strain relief to the fiber optic cable 10 and the connector housing 110. The fiber optic connector assembly 100 may further include an o-ring 161 positioned between the boot 160 and a cable adapter 140, as described in greater detail herein. While embodiments described herein include the boot 160, it should be understood that other features may be utilized to assist in sealing internal components of the fiber optic connector assembly 100 and providing strain relief, such as overmolds or the like.

Referring particularly to FIG. 1E, in some embodiments, the boot 160′ is rotationally asymmetric such that a user (e.g., a technician) can readily identify a rotational orientation of the fiber optic connector assembly 100. In particular, as the fiber optic connector assembly 100 is rotated about the axial direction (e.g., about the longitudinal axis 114), the boot 160′ of the fiber optic connector assembly 100 does not look the same after a partial turn about the axial direction. In the embodiment depicted in FIG. 1F, the boot 160′ extends between a boot rearward end 162′ and a boot forward end 164′, and the boot rearward end 162′ asymmetrically tapers inward toward the fiber optic cable 10. While in the embodiment depicted in FIG. 1F, the rotational asymmetry of the boot 160′ results from the asymmetric taper of the boot rearward end 162′, it should be understood that this is merely an example. In some embodiments, the optical port 20 may similarly include a boot that is rotationally asymmetric, such that a technician may readily rotationally align the optical port 20 and the fiber optic connector assembly 100.

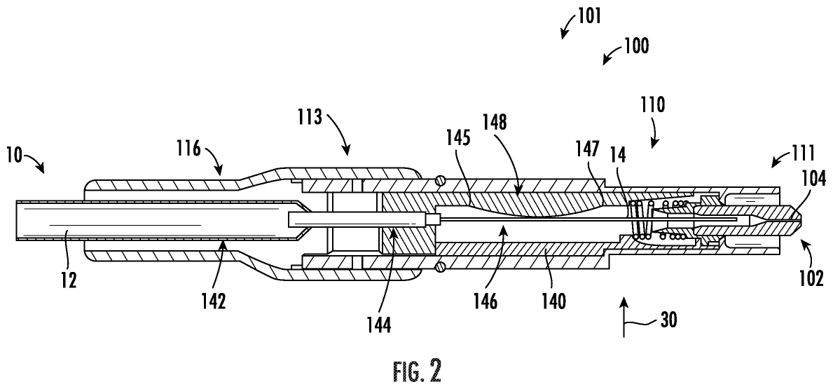

Referring to FIG. 2, a section view of the connectorized fiber optic cable assembly 101 along section 2-2 of FIG. 1D is schematically depicted. In embodiments, the fiber optic connector assembly 100 further includes a cable adapter 140 engaged with the connector housing 110. In particular, in the embodiment depicted in FIG. 2, the cable adapter 140 is positioned at least partially into the rear portion 113 of the connector housing 110. The boot 160 is positioned at least partially over the connector housing 110 and the cable adapter 140, in embodiments. In embodiments, the fiber optic cable 10 and/or the connector housing 110 may be coupled to the cable adapter 140, for example through an adhesive or the like.

The cable adapter 140 generally includes an optical cable passageway 142 and an optical fiber passageway 144. The fiber optic cable 10 extends along the optical cable passageway 142, and the optical fiber 14 of the fiber optic cable 10 extends along the optical fiber passageway 144 to the optical fiber bore 104 of the ferrule 102. In embodiments, the optical cable passageway 142 is positioned rearward of the optical fiber passageway 144. The optical cable passageway 142 is generally sized to accommodate the cable jacket 12, and the optical fiber passageway 144 is generally sized to accommodate the optical fiber 14. In some embodiments, the optical fiber passageway 144 is smaller than the optical cable passageway 142. Accordingly, the optical fiber passageway 144 may limit the insertion of the cable jacket 12 into the cable adapter 140.

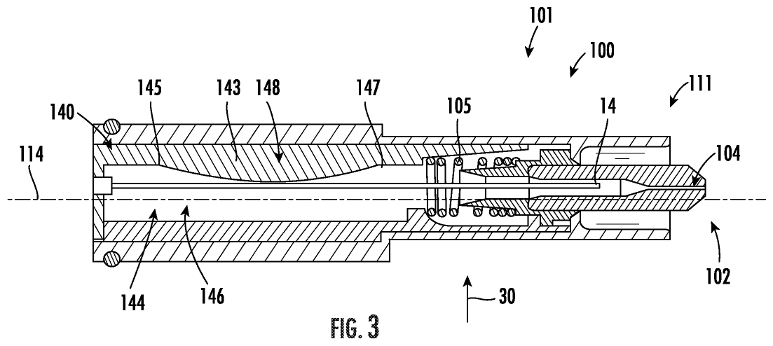

In embodiments, the optical fiber passageway 144 defines a fiber buckling passageway 146 and an inducement feature 148 extending at least partially into the fiber buckling passageway 146. The fiber buckling passageway 146 is generally eccentric to the centrally-disposed longitudinal axis 114 of the connector housing 110. For example, as shown in FIG. 3, the longitudinal axis 114 of the connector housing 110 is proximate to a bottom surface of the fiber buckling passageway 146 and distal from a top surface of the fiber buckling passageway 146. In embodiments, the optical fiber 14 generally extends along the bottom surface of the fiber buckling passageway 146 when at rest e.g., when not under force applied in the axial direction).

The inducement feature 148 is structurally configured to preferentially buckle the optical fiber 14 extending along the fiber buckling passageway 146. In the embodiment depicted in FIG. 2, the inducement feature 148 is structurally configured to preferentially buckle the optical fiber 14 in a buckling direction 30. For example and referring to FIG. 3, an enlarged section view of the front portion 111 of the connector housing 110 and the cable adapter 140 is schematically depicted. In embodiments, the inducement feature 148 is rotationally discrete evaluated around the fiber buckling passageway 146. As used herein, the term “rotationally discrete” represents a limited width-wise extent along an inner surface of the fiber buckling passageway 146, as the connector housing 110 is rotated about its centrally-disposed longitudinal axis 114.

In embodiments, the inducement feature 148 defines a curved shape extending from a rearward portion 145 of the fiber buckling passageway 146 to a forward portion 147 of the fiber buckling passageway 146. The inducement feature 148 includes a medial portion 143 positioned between the rearward portion 145 of the fiber buckling passageway 146 and the forward portion 147 of the fiber buckling passageway 146, where the medial portion 143 is positioned radially inward of the forward portion 147 of the fiber buckling passageway 146 and the rearward portion 145 of the fiber buckling passageway 146.

In embodiments, as the ferrule 102 and the optical fiber 14 move rearward in the axial direction, the optical fiber 14 preferentially buckles in the buckling direction 30, conforming to the curve of the inducement feature 148. For example, in some embodiments, the ferrule 102 is biased toward the front portion 111 of the connector housing 110. In the embodiment depicted in FIG. 3, the fiber optic connector assembly 100 includes a biasing member 105 engaged with the connector housing 110, biasing the ferrule 102 toward the front portion 111 of the connector housing 110. The ferrule 102 may be moved rearward in the axial direction, for example, as the fiber optic connector assembly 100 is engaged with the optical port 20 (FIG. 1F). In particular, the ferrule 102 may contact components of the optical port 20 (FIG. 1F), thereby moving the female 102 rearward in the axial direction. As noted above, in embodiments, the optical fiber 14 may be coupled to the optical fiber bore 104 of the ferrule 102, and accordingly, as the ferrule 102 moves rearward in the axial direction, the optical fiber 14 also moves rearward in the axial direction.

However, as noted above, in embodiments, the cable adapter 140 is coupled to the fiber optic cable 10 (FIG. 2). Accordingly, rearward movement of the optical fiber 14 in the axial direction is restricted, and the optical fiber 14 generally buckles (e.g., moves outward in the radial direction) as the ferrule 102 moves rearward in the axial direction. Because the inducement feature 148 extends radially inward into the fiber buckling passageway 146, as the optical fiber 14 buckles, the optical fiber 14 generally engages the inducement feature 148. In particular, the optical fiber 14 engages the medial portion 143 of the inducement feature 148 and buckles to conform to a curve of the inducement feature 148.

As the optical fiber 14 buckles to conform to the inducement feature 148, the optical fiber 14 buckles in the buckling direction 30. As noted above, the optical fiber 14 generally extends along the bottom surface of the fiber buckling passageway 146 at rest, and the fiber buckling passageway 146 is eccentric to the centrally-disposed longitudinal axis 114. Accordingly, radial movement of the optical fiber 14 is limited, and the optical fiber 14 is thereby induced to buckle in the buckling direction 30 when the optical fiber 14 moves rearward in the axial direction.

By inducing the optical fiber 14 to buckle in the buckling direction 30, the perimeter of the cable adapter 140, and accordingly the perimeter of the fiber optic connector assembly 100 may be reduced as compared to conventional fiber optic connector assemblies. For example to accommodate fiber buckling, conventional cable adapters generally include fiber buckling chambers that allow optical fibers to buckle in any radially outward direction. However, by inducing the optical fiber 14 to buckle in a specific buckling direction 30, the radial size of the fiber buckling passageway 146 may be reduced. By reducing the radial size of the fiber buckling passageway 146, the overall radial size of the cable adapter 140, and accordingly the form factor of the fiber optic connector assembly 100 may be reduced. For example, in some embodiments, the connector assembly 100 has a cylindrical shape and the outer diameter of the fiber optic connector assembly 100 may be less than about 8 millimeters.

Referring to FIG. 4, the ferrule 102 is schematically depicted in isolation. In embodiments, the ferrule 102 may include a ferrule positioned at least partially within a ferrule holder. In some embodiments, the ferrule 102 includes at least one ferrule keying feature. In the embodiment depicted in FIG. 4 the ferrule 102 includes a first ferrule keying feature 120 and a second ferrule keying feature 120′. The ferrule keying features 120, 120′ are structurally configured to engage corresponding keying features of the connector housing 110 (FIG. 3) to rotationally align the ferrule 102 with the connector housing 110.

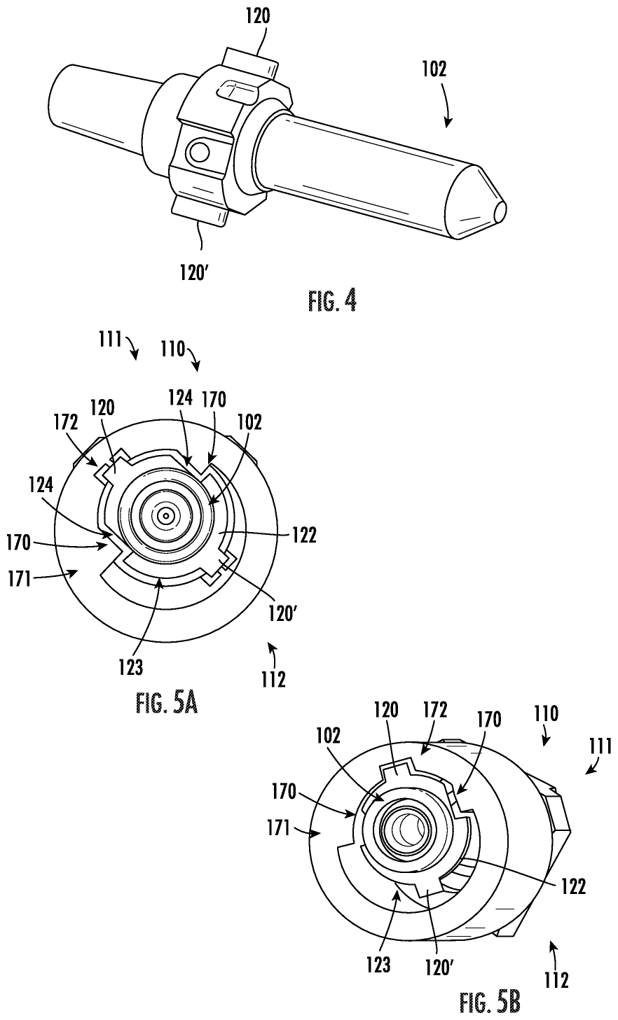

For example and referring to FIGS. 5A and 5B, a section view of the front portion 111 of the connector housing 110 and the ferule 102 is schematically depicted. In embodiments, the front portion 111 of the connector housing 110 defines a connector keying feature 172 that is structurally configured to engage one of the ferrule keying features 120, 120′.

In embodiments, the front portion 111 of the connector housing 110 further includes a connector rotational guide 171 that is engaged with a ferrule rotational guide 123 of the ferrule 102. For example in the embodiment depicted in FIGS. 5A and 5B, the ferrule rotational guide 123 of the ferrule 102 includes a flange 122 that extends partially around the perimeter of the ferrule 102, and at least one cutout 124 that interrupts the flange 122. In the embodiment depicted in FIGS. 5A and 5B the ferrule 102 includes a pair of cutouts 124 that interrupt the flange 122. In embodiments, the connector rotational guide 171 of the connector housing 110 includes protrusions 170 that correspond to the pair of cutouts 124 of the ferrule 102. In some embodiments, the ferrule 102 is a ferrule such as may be utilized in an SC connector.

The cutouts 124 of the ferrule 102 and the protrusions 170 of the connector housing 110, and the ferrule keying feature 120, 120′ of the ferrule 102 and the connector keying feature 172 of the connector housing 110 generally permit installation of the ferrule 102 into the connector housing 110 in only one rotational orientation. By permitting installation of the ferrule 102 into the connector housing 110 in only one rotational orientation, the ferrule 102 may only be installed in a desired rotational orientation, which may assist in reducing coupling loss when the fiber optic connector assembly 100 is optically coupled to a port. While in the embodiment depicted in FIGS. 5A and 5B the ferrule keying features 120, 120′ are depicted as keys and the connector keying feature 172 is depicted as a corresponding keyway, it should be understood that this is merely an example, and the ferrule keying features 120, 120′ and the connector keying feature 172 may include any suitable complementary shapes. Moreover, while in the embodiment depicted in FIGS. 5A and 5B the ferrule rotational guide 123 is depicted as including the flange 122 including the cutouts 124, and the connector rotational guide 171 is depicted as including the pair of protrusions 170, it should be understood that this is merely an example and the ferrule rotational guide 123 and the connector rotational guide 171 may include any suitable complementary shapes.

It should now be understood that embodiments of the present disclosure are directed to connectorized fiber optic cable assemblies including one or more asymmetric features that assist in reducing an outer perimeter of the connectorized fiber optic cable assembly (i.e., reducing the form factor of the connectorized fiber optic cable assembly). By reducing the form factor of connectorized fiber optic cable assembly, optical cable assemblies described herein may be suitable for use in environments having limited space, such as ducts and the like. Moreover, by reducing the form factor of the connectorized fiber optic cable assembly, the density of adjacent optical cable assemblies connected to a port connection assembly, such as a multiport, can be increased.

It is noted that recitations herein of a component of the present disclosure being “structurally configured” in a particular way, to embody a particular property, or to function in a particular manner, are structural recitations, as opposed to recitations of intended use. More specifically, the references herein to the manner in which a component is “structurally configured” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

For the purposes of describing and defining the present invention it is noted that the terms “substantially” and “about” are utilized herein to represent the inherent degree of uncertainty that may be attributed to any quantitative comparison, value, measurement, or other representation. The terms “substantially” and “about” are also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

1. A fiber optic connector assembly terminating an optical fiber, the fiber optic connector comprising:
a connector housing comprising a front portion positioned opposite a rear portion of the connector housing and a centrally-located longitudinal axis extending from the front portion of the connector housing to the rear portion of the connector housing;
a ferrule comprising an optical fiber bore, wherein the optical fiber bore is offset from the centrally-located longitudinal axis;
a cable adapter engaged with the connector housing and comprising an optical cable passageway and an optical fiber passageway, the optical fiber passageway defining a fiber buckling passageway and an inducement feature extending at least partially into the fiber buckling passageway, wherein the inducement feature is structurally configured to preferentially buckle an optical fiber extending along the fiber buckling passageway; and
a boot positioned at least partially over the connector housing and the cable adapter, wherein the boot is rotationally asymmetric about an axial direction and comprises a boot forward end and a rearward end with the rearward end asymmetrically tapering to the fiber optic cable.

2. The fiber optic connector assembly of claim 1, wherein the inducement feature defines a curved shape extending from a rearward portion of the fiber buckling passageway to a forward portion of the fiber buckling passageway.

3. The fiber optic connector assembly of claim 2, wherein the inducement feature comprises a medial portion positioned between the rearward portion of the fiber buckling passageway and the forward portion of the fiber buckling passageway, wherein the medial portion is positioned radially inward of the forward portion of the fiber buckling passageway and the rearward portion of the fiber buckling passageway.

4. The fiber optic connector assembly of claim 1, wherein the inducement feature is rotationally discrete evaluated around the fiber buckling passageway.

5. The fiber optic connector assembly of claim 1, wherein the fiber buckling passageway is eccentric to the longitudinal axis.

6. The fiber optic connector assembly of claim 1, wherein the front portion of the connector housing defines a connector keying feature structurally configured to engage a corresponding ferrule keying feature of a ferrule.

7. The fiber optic connector assembly of claim 1, wherein the front portion of the connector housing defines a perimeter that is offset from the longitudinal axis.

8. (canceled)

9. A connectorized fiber optic cable assembly comprising:
a connector housing comprising a front portion positioned opposite a rear portion of the connector housing and a centrally-located longitudinal axis extending from the front portion of the connector housing to the rear portion of the connector housing;
a cable adapter engaged with the connector housing and comprising an optical cable passageway and an optical fiber passageway, the optical fiber passageway defining a fiber buckling passageway and an inducement feature extending at least partially into the fiber buckling passageway;
a ferrule positioned at least partially within the connector housing, the ferrule comprising an optical fiber bore, wherein the optical fiber bore is offset from the centrally-located longitudinal axis;
a fiber optic cable extending along the optical cable passageway of the cable adapter, the fiber optic cable comprising an optical fiber extending along the optical fiber passageway to the optical fiber bore of the ferrule, wherein the inducement feature of the cable adapter is structurally configured to preferentially buckle the optical fiber; and
a boot positioned at least partially over the connector housing and the cable adapter, wherein the boot is asymmetric about an axial direction and comprises a boot forward end and a rearward end with the rearward end asymmetrically tapering to the fiber optic cable.

10. The connectorized fiber optic cable assembly of claim 9, wherein the inducement feature defines a curved shape extending from a rearward portion of the fiber buckling passageway to a forward portion of the fiber buckling passageway.

11. The connectorized fiber optic cable assembly of claim 10, wherein the inducement feature comprises a medial portion positioned between the rearward portion of the fiber buckling passageway and the forward portion of the fiber buckling passageway, wherein the medial portion is positioned radially inward of the forward portion of the fiber buckling passageway and the rearward portion of the fiber buckling passageway.

12. The connectorized fiber optic cable assembly of claim 9, wherein the inducement feature is rotationally discrete evaluated around the fiber buckling passageway.

13. The connectorized fiber optic cable assembly of claim 9, wherein the front portion of the connector housing defines a connector keying feature engaged with a ferrule keying feature of the ferrule.

14. The connectorized fiber optic cable assembly of claim 9, wherein the front portion of the connector housing defines a connector rotational guide engaged with a ferrule rotational guide of the ferrule.

15. The connectorized fiber optic cable assembly of claim 9, wherein the front portion of the connector housing defines a perimeter that is offset from the longitudinal axis.

16. (canceled)

17. A method for optically coupling a connectorized fiber optic cable assembly to a port, the method comprising:
optically coupling an optical fiber of a connectorized fiber optic cable assembly to an optical port, the connectorized fiber optic cable assembly comprising a connector housing having a centrally-located longitudinal axis, a cable adapter engaged with the connector housing and comprising an optical cable passageway and an optical fiber passageway, the optical fiber passageway defining a fiber buckling passageway and an inducement feature extending at least partially into the fiber buckling passageway, a ferrule positioned at least partially within the connector housing, the ferrule comprising an optical fiber bore, and a fiber optic cable extending along the optical cable passageway of the cable adapter, the fiber optic cable comprising the optical fiber extending along the optical fiber passageway to the optical fiber bore of the ferrule, wherein the optical fiber bore is offset from the centrally-located longitudinal axis;
engaging the optical fiber of the connectorized fiber optic cable assembly with the inducement feature, thereby preferentially buckling the optical fiber of the connectorized fiber optic cable assembly in a buckling direction; and
positioning a boot at least partially over the connector housing and the cable adapter, wherein the boot is asymmetric about an axial direction and comprises a boot forward end and a rearward end with the rearward end asymmetrically tapering to the fiber optic cable.

18. The method of claim 17, further comprising moving the ferrule and the optical fiber of the connectorized fiber optic cable assembly rearward in an axial direction.

19. The method of claim 17, wherein engaging the optical fiber of the connectorized fiber optic cable assembly with the inducement feature comprises engaging a medial portion of the inducement feature with the optical fiber and buckling the optical fiber to conform to a curve of the inducement feature.
